(19) United States
(12) Patent Application Publication
(10) Pub. No.: US 2025/0105780 A1
(43) Pub. Date: Mar. 27, 2025

(54) System and Method for Automatically Cleaning Solar Collection Optical Components

(71) Applicant: Exowatt, Inc., Miami, FL (US)

(72) Inventors: Hannan PARVIZIAN, Miami, FL (US); Sushrut BAPAT, Miami, FL (US)

(21) Appl. No.: 18/899,928

(22) Filed: Sep. 27, 2024

Related U.S. Application Data
(60) Provisional application No. 63/585,801, filed on Sep. 27, 2023.

(51) Int. Cl. H02S 40/10; B64U 20/80; B64U 101/29; B64U 101/45

(52) U.S. Cl. CPC H02S 40/10; B64U 20/80; B64U 2101/29; B64U 2101/45

(57) ABSTRACT

A solar array cleaning system uses an unmanned aerial vehicle(s) to automatically spray a cleaning solution onto each mirrored surface of the solar array.

### CROSS-REFERENCE TO RELATED APPLICATION

This application is a non-provisional of U.S. patent application No. 63/585,801 filed Sep. 27, 2023, incorporated herein by reference.

### FIELD

This technology relates to solar collectors, and more particularly to automating cleaning of optical components such as concentrators, lenses and reflectors of a solar collector array.

### BACKGROUND & SUMMARY

Dust and debris such as bird droppings can dirty the optical components such as lenses and reflector mirrors of solar collection arrays, reducing collection efficiency. Such arrays should therefore be cleaned periodically to maintain high efficiency.

Unfortunately, large solar collectors can be difficult to clean. Even if their structures are ruggedly designed to withstand wind and weather, they may not be able to support a human engaged in cleaning the array. Furthermore, some such arrays are very high off the ground and may be curved or parabolic. Therefore access by ladder may be impractical or difficult. While it may be possible to power wash the optical components from the ground, a great deal of cleaning fluid may be wasted due to gaps between the optical components.

Drones have been used to clean windows of tall buildings. It would be desirable to use drones to clean or assist in cleaning a solar collection array.

### BRIEF DESCRIPTION OF THE DRAWINGS

FIG. 1 shows an example solar collection array with one or several drones engaged in automatically cleaning array reflectors.

FIG. 2 is an example system block diagram.

FIG. 3 is an example drone block diagram.

FIG. 4 is an example drone control flowchart.

### DETAILED DESCRIPTION OF NON-LIMITING EMBODIMENTS

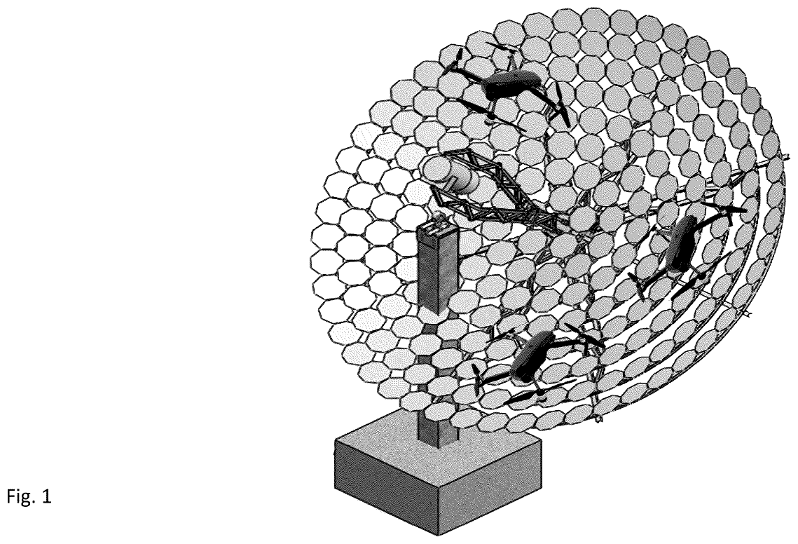

FIG. 1 shows an example solar collection array with one or several drones (unmanned aerial vehicles) engaged in automatically cleaning array reflectors or other optical components of the solar collection array. In one embodiment, a single drone is used to clean the array (the different instances of the drone shown in FIG. 1 are locations of the single drone at different times). In another embodiment, multiple drones may be used simultaneously to clean different parts of the array.

In some embodiments, each drone sprays a cleaning solution onto the reflectors to be cleaned, the cleaning solution washing the reflectors and then dripping off and/or evaporating to leave clean mirrored and/or refractive surfaces. In other embodiments, each drone may wipe or rub a polishing surface onto each optical component such as reflector in order to clean and polish the components. In some embodiments, the drone(s) may use both a cleaning solution and a polishing action to clean the array reflectors.

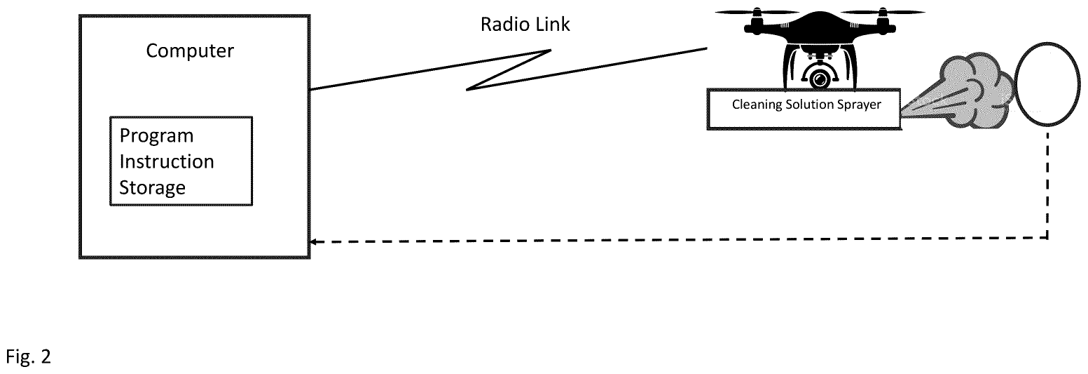

FIG. 2 shows an automatic cleaning system including a base station computer and a drone. In one embodiment, the base station computer may wirelessly, interactively send control commands to the drone to direct the drone to clean mirrored and/or refractive and/or other surfaces of the array. Such interactive control may be based on the base station computer monitoring power or heat sensors that in turn monitor the power collection efficiency of the array. Such a feedback loop (see dotted line monitoring path) allows the base station computer to interactively measure the effectiveness of cleaning by the drone and further control the drone to achieve a desired cleaning effectiveness.

In other embodiments, the base station computer may program the drone by providing navigation information to enable the drone to autonomously navigate to mirrors of the collection array for purposes of cleaning the optical surfaces.

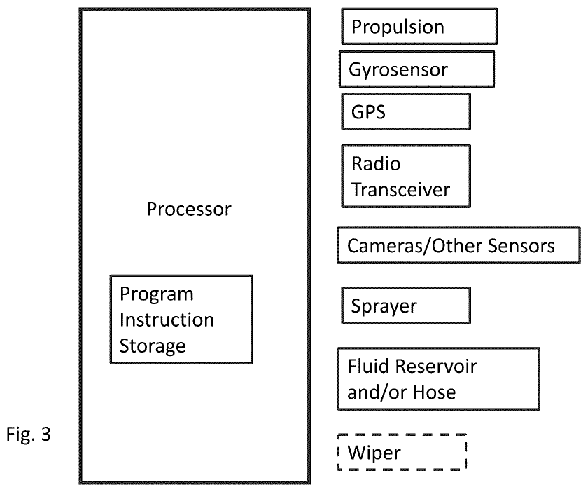

FIG. 3 is a block diagram of an example drone. In this embodiment, the drone comprises a processor including a non-transitory program control storage. The processor executes instructions stored in such storage to autonomously perform operations. The processor may in turn be coupled to various additional functional units onboard the drone including but not limited to:
Propulsion (e.g., 2, 4, 6 or more VTOL propellers)
A gyrosensor
A GPS (global positioning system) sensor
A radio transceiver
Cameras and/or other sensors
A fluid sprayer (which may in turn be coupled to a fluid reservoir and/or a hose)
An optional wiping device.

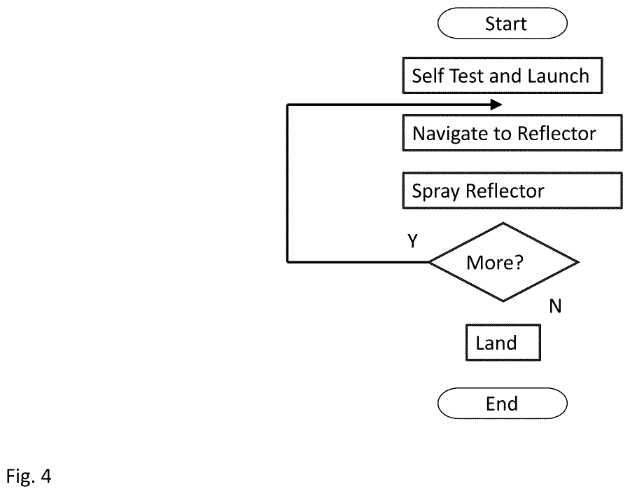

FIG. 4 shows an example flowchart of autonomous operation performed by the drone either by itself or in conjunction with the base station computer. After self-test and launch, the drone navigates to an optical surface such as a lens or mirror of the solar array and cleans it e.g., by spraying a cleaning solution on it (and/or by wiping it). This process continues for each of the optical components in the array. When all optical surfaces have been cleaned, the drone may land, or it may be directed to the optical surfaces of another array.

In some embodiments, the drone may be replaced by an articulated robotic arm(s) mounted to the solar array.

All patents and publications cited herein are expressly incorporated by reference for purposes of background and enablement but should not be used or applied as a basis for disclaiming subject matter.

While the invention has been described in connection with what is presently considered to be the most practical and preferred embodiments, it is to be understood that the invention is not to be limited to the disclosed embodiments. On the contrary, is intended to cover various modifications and equivalent arrangements included within the spirit and scope of the appended claims.

1. An autonomous solar collector cleaning system comprising:
at least one processor executing stored program control instructions, the at least one processor being operative coupled to an unmanned aerial vehicle;
the unmanned aerial vehicle including a fluid dispenser;
the at least one processor controlling the unmanned aerial vehicle to sequentially wash a plurality of optical surfaces of a solar collector array.

2. The system of claim 1 wherein the unmanned aerial vehicle is configured to spray a cleaning solution on each of the plurality of optical surfaces in turn.
